(19) United States
(12) Patent Application Publication
(10) Pub. No.: US 2010/0026813 A1
(43) Pub. Date: Feb. 4, 2010

(54) Video monitoring involving embedding a video characteristic in audio of a video/audio signal

(75) Inventors: Takahiro Hamada, Yokohama (JP); Muhammad Farooq Sabir, San Jose, CA (US); Chung Chieh Kuo, Arcadia, CA (US); Byung-Ho Cha, Los Angeles, CA (US)

Correspondence Address: IMPERIUM PATENT WORKS, P.O. BOX 607, Pleasanton, CA, 94566, US

(73) Assignees: K-WILL Corporation; The University of Southern California

(21) Appl. No.: 12/221,285

(22) Filed: Jul. 31, 2008

(51) Int. Cl. H04N 17/00

(52) U.S. Cl. 348/180; 348/E17.001

(57) ABSTRACT

A first video characteristic value is determined from a video/audio signal. The first video characteristic value is embedded in an audio portion of the video/audio signal and the video/audio signal is transmitted from a transmission source to a transmission destination. At the destination, the first video characteristic value is recovered and the received video/audio signal is used to determine a second video characteristic value. The recovered first video characteristic value is used to verify or check the second video characteristic value. By comparing the first and second video characteristic values, a determination is made about degradation of the received video/audio signal. In one example, a determination is made as to whether a lip-sync error has likely occurred. In another example, the audio-transmitted first video characteristic is used for copyright protection purposes.

### TECHNICAL FIELD

The present invention relates to monitoring of digital video/audio signals.

### BACKGROUND INFORMATION

Video quality assessment is currently one of the most challenging problems in the broadcasting industry. No matter what the format of the coded video or the medium of transmission, there are always sources that cause degradation in the coded/transmitted video. Almost all of the current major broadcasters are concerned with the notion of “How good will our video look at the receiver?” Currently, there are very few practical methods and objective metrics to measure video quality. Also, most current metrics/methods are not feasible for real-time video quality assessment due to their high computational complexity.

Watermarking is a technique whereby information is transmitted from a transmitter to a receiver in such a way that the information is hidden in an amount of digital media. A major goal of watermarking is to enhance security and copyright protection for digital media.

Whenever a digital video is coded and transmitted, it undergoes some form of degradation. This degradation may be in many forms, for example, blocking artifacts, packet loss, black-outs, lip-synch errors, synchronization loss, etc. Human eyes and ears are very sensitive to these forms of degradation. Hence it is beneficial if the transmitted video undergoes no or only a minimal amount of degradation and quality loss. Almost all the major broadcasting companies are competing to make their media the best quality available. However, in order to improve video quality, methods and metrics are required to determine quality loss. Unfortunately, most of the quality assessment metrics currently available rely on having some form of the original video source available at the receiver. These methods are commonly referred to as Full Reference (FR) and Reduced Reference (RR) quality assessment methods. Methods that do not use any information at the receiver from the original source are called No Reference (NR) quality assessment methods.

While FR and RR methods have the advantage of estimating video quality with high accuracy, they require a large amount of transmitted reference data. This significantly increases the bandwidth requirements of the transmitted video, making these methods impractical for real-time systems (e.g. broadcasting). NR methods are ideal in applications where the original media is not needed in the receiver. However, the measurement accuracy is low, and the complexity of the blind detection algorithm is high.

Watermarking in digital media has been used for security and copyright protection for many years. In watermarking, information is imperceptibly embedded in the digital media. The embedded information can be of many different forms ranging from encrypted codes to pilot patterns, in the digital media at the encoder. Then, at the decoder, the embedded information is recovered and verified, and in some cases removed from the received signal before opening/playing/displaying it. If there is a watermark mismatch, the decoder identifies a possible security/copyright violation and does not open/play/display the digital media contents. Such watermarking has become a common way to ensure security and copyright preservation in digital media, especially digital images, audio and video content.

Digital video is, however, often subjected to compression (MPEG-2, MPEG-4, H.263, etc.) and conversion from one format to another (HDTV-SDTV, SDTV-CIF, TV-AVI, etc.). Due to composite processing involving compression, format conversion, resolution changes, brightness changes, filtering, etc., the embedded watermark can be easily destroyed such that it cannot then be decoded at the receiver. This may result in either a security/copyright breach and/or distortion in the decoded video. One such scenario is illustrated in FIG. 1.

Also, it is often difficult to embed imperceptible watermarks in high quality videos. Therefore, the embedding strength of video watermarking is limited by imperceptibility. In this situation, hybrid channel distortion makes it difficult for watermarks to survive in video.

In recent years, video processing techniques have improved, and high-quality video broadcasts, such as a high-definition television (HDTV) broadcasts, are common. Digital video signals of a high-definition television broadcast, etc., are often transmitted to each home through satellite broadcasting or a cable TV network. However, an error sometimes occurs during the transmission of video signals from various causes. When an error occurs, problems, such as a video freeze, a blackout, noise, audio mute, etc., may result, and thus it becomes necessary to take countermeasures.

Japanese Patent Application Laid-Open No. 2003-20456 discloses a signal monitoring system in which a central processing terminal calculates a difference between a first statistic value based on a video signal (first signal) output from a transmission source and a second statistic value based on a video signal (second signal) output from a relay station or a transmission destination. If the difference is below a threshold value, then the transmission is determined to be normal, whereas if the difference is over the threshold value then a determination is made that transmission trouble has occurred between the transmission source and the relay station so that a warning signal can be output to raise an alarm (alarm display and alarm sound).

### SUMMARY

A novel monitoring method provides a reliable way to monitor the quality of video and audio, while at the same time not demanding substantially more data to be broadcast. In one example of the novel monitoring method, a first video characteristic of a video/audio signal is determined. The term “video/audio signal” as the term is used here generally refers to a signal including both a picture signal (video signal) and an associated sound signal (audio signal). The video/audio signal can be either a raw signal or may involve compressed video/audio information.

The video/audio signal is transmitted from a transmission source to a transmission destination. The first video characteristic is communicated in an audio signal portion of the video/audio signal. This audio-transmitted video characteristic is usable for copyright protection and/or for measuring and improving video quality.

The video/audio signal is received at the transmission destination and the first video characteristic is recovered from the audio signal portion of the video/audio signal. The video/audio signal is also analyzed and a second video characteristic is thereby determined. The same algorithm is used to determine the second video characteristic from the received video and audio signal as was used to determine the first video characteristic from the original video and audio signal prior to transmission.

The recovered first video characteristic is then used to verify or test the determined second video characteristic. If the difference between the first and second video characteristics is greater than a predetermined threshold amount, then an error condition is determined to have occurred. For example, if appropriate parameters are used, then it is determined that a lip-sync error condition likely occurred. If, however, the difference between the first and second video characteristics is below the predetermined threshold amount, then it is determined that an error condition has likely not occurred.

In one example, the first and second video characteristics are determined based at least in part on video frame statistic parameters and are referred to here as “VDNA” (Video DNA) values. A VDNA value may, for example, be a concatenation of many video frame parameter values that are descriptive of, and associated with, a single frame or a group of frames of video. The video frame statistic parameters may together characterize the amount of activity, variance, and/or motion in the video of the video/audio signal. The parameters are used by a novel monitoring apparatus to evaluate video quality using the novel monitoring method set forth above. The amount of information required to be transmitted from the transmission source to the transmission destination in the novel monitoring method is small because the first characteristic, in one example, is communicated using fewer than one hundred bits per frame. Furthermore, in one example the novel quality assessment monitoring method is based on block variance parameters, as more particularly described below, and has proven to be highly accurate.

Further details, embodiments and techniques are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the monitoring method.

FIG. 1 (Prior Art) is a schematic diagram of a method of adding a watermark to a video frame, compressing or converting the frame, and then having difficulty reading the watermark because of the compression or conversion.

FIG. 2 is a schematic diagram of a novel method. In the method, a first video characteristic is determined from a first frame of video. The first video characteristic is then embedded into the audio associated with the video frame. The result is then compressed and/or format converted, and is transmitted. After transmission, the video and audio are recovered and separated. A second video characteristic is determined from the received and recovered video frame. The first video characteristic as recovered from the transmitted video and audio is then compared with the second video characteristic to make a determination about the quality of the received video and audio.

FIG. 3 is a schematic diagram of the monitoring method illustrated in FIG. 2, with added detail.

FIG. 4 is a simplified flowchart of an example of the monitoring method of FIG. 3.

FIG. 5 is a schematic diagram of a novel transmission system that employs the novel monitoring method of FIG. 4.

FIG. 6 is a block diagram of one example of apparatuses 100X, 100A, and 100B of FIG. 5.

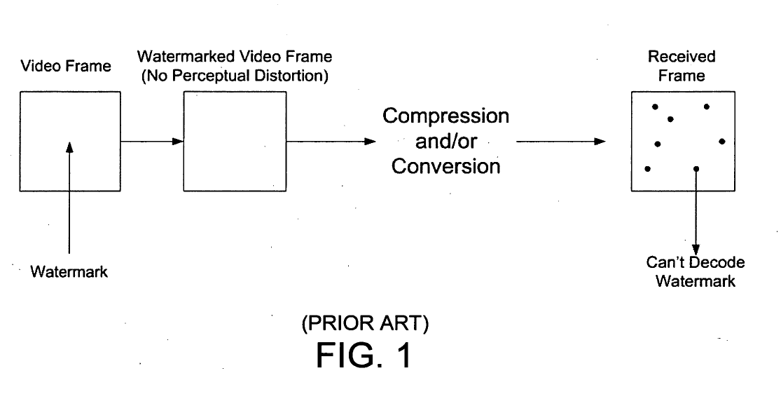

### DESCRIPTION OF A PREFERRED EMBODIMENT

In one example of a monitoring method, a first video characteristic, hereinafter referred to as the first VDNA, is extracted at an encoder/transmitter from a video frame of a video/audio signal. This first VDNA is then embedded in an audio signal portion of the video/audio signal. The audio signal portion corresponds to the video frame. The group of audio samples corresponding to the same video frame is referred to here as an “audio frame”.

At the receiver, the embedded first VDNA is extracted from the audio signal portion of the received video/audio signal. A second VDNA is computed from the received video frame. The same algorithm may be used to determine the second VDNA from the received video frame as was used to determine the first VDNA from the original video frame prior to transmission. The first and second VDNAs are then compared to each other. Depending on the type of application, different decisions can be made if the VDNAs and VDNA parameters do not match. For example, in a security/copyrights application, in the case of VDNA mismatch, the application may declare a breach. From the point of view of quality assessment, a VDNA mismatch may indicate a loss of quality and/or the presence of errors and distortion in the received video.

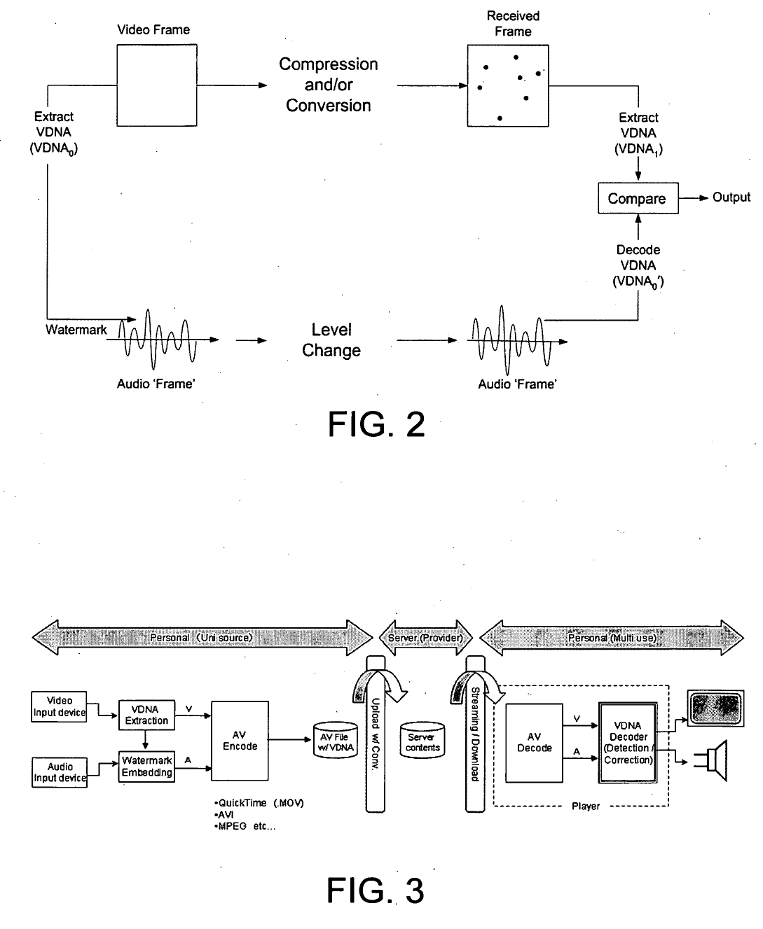

FIG. 2 illustrates the novel monitoring method in greater detail. VDNA₀ represents first VDNA parameters extracted from the original video frame. VDNA₀ is embedded into the audio signal. At the receiver, VDNA₁ represents the second VDNA extracted from the received video frame. Note that these parameters can be different from the first VDNA₀ parameters because the video frame may have gone through compression or conversion, or may have undergone distortion. Also in FIG. 2, VDNA₀′ represents the first VDNA as decoded from the received audio signal. Note that these first VDNA parameters should be equal to VDNA₀ if the characteristic is correctly decoded. The second VDNA₁ and the recovered first VDNA₀′ are then compared, and the result of the comparison is passed on to a conventional device to look at security/copyright, quality assessment, etc.

FIG. 3 illustrates this method of using VDNA in a real-world video sequence (.avi, MPEG, etc.). More particularly, FIG. 3 illustrates what part of the method occurs at the transmission or single origination source, what is broadcast, and then what is received by the multiple users or receivers of the broadcast.

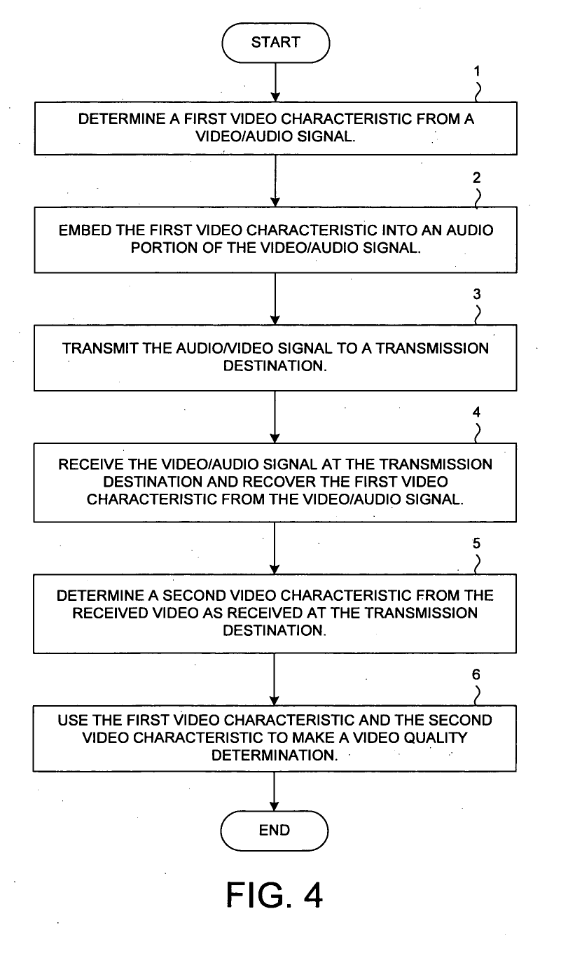

FIG. 4 is a simplified flowchart of one example of the method. The video/audio signal is supplied to a transmitter, and the first VDNA is determined (step 1) from the video. The determined first VDNA is embedded (step 2) into the audio signal, as further explained below. The combined video/audio signal then undergoes encoding. The resulting encoded signal is then put on the transmitter's server with appropriate compression or format conversion. The resulting file is then streamed or downloaded or broadcast or otherwise transmitted (step 3) to multiple respective receivers. A receiver or video/audio player receives the video/audio signal (step 4), decodes the video/audio file and recovers the first VDNA from the audio signal. The receiver also determines the second VDNA (step 5) from the received video. The first and second VDNAs are then compared. In one example, the first and second VDNAs are used to make a determination (step 6) about the quality of the received video or degradation of the transmission. The received video and audio are also output to the viewing and listening equipment of the receivers.

Many different characteristics or parameters can be used as the video characteristic. However, it is desirable that the chosen parameters be relatively insensitive to format conversion or compression. This is because digital videos often undergo format conversions or compression. Because of this, some frame statistics change, making the choice of certain parameters useless. Through extensive simulations, it has been determined that the characteristics corresponding to scene change are less sensitive to format conversions. Hence, in the preferred embodiment, a parameter is used that represents the block variance of the difference between two consecutive frames. Whenever this parameter has a high value, it means that a scene change has likely occurred. This high valued parameter is then used as the video frame parameter for all the frames until the next scene change is encountered.

There are several suitable methods for adding and encoding the first VDNA into the audio signal. These various methods are generally referred to as audio watermarking. Two such generally known methods are Quantization Index Modulation (QIM) and Spread Transform Dither Modulation (STDM). Both are recognized watermark embedding and detection methods, and are usable with the preferred monitoring method. Both are well-developed methods, and are briefly described below.

QIM is a general class of embedding and decoding methods that uses a quantized codebook (sometimes called code-set). There are two practical implementations for QIM, which are Dither Modulation (DM) and Spread Transform Dither Modulation (STDM).

DM consists of information bits (i.e., user ID, VDNA, encrypted message), dither vectors (i.e. a kind of repetition code to provide redundancy), an embedder which has a quantization operation, and decoder that performs a minimum distance decoding. The strength of DM is adjusted by a step size Δ.

For embedding, it is assumed that the information bits contain 0 and 1. Two dither vectors are generated from a random sequence and a step size Δ for bit 0 and bit 1, named dither_0 and dither_1, respectively. The following steps constitute watermark embedding. 1) If bit 0 is selected, dither_0 is applied for embedding. 2) Host media (original media) is added to dither_0 and quantization is carried out. 3) Then, dither_0 is subtracted from the quantized result. And note that similar steps are carried out for bit 1.

The following steps are carried out at the decoder. 1) Dither_0 is added to the received (watermarked and attacked) media (same step for dither_1). 2) Quantization is carried out on the resulting data and dither_0 and dither_1 are subtracted from their respective quantized results. 3) The respective quantized results are then subtracted from the received media, and the two summations of all root-squared results from dither_0 and dither_1 are compared. 4) Then, the transmitted information bit is decided based on the smaller value of the summation (minimum distance decoding).

STDM involves information bits (i.e., user ID, VDNA, encrypted message), dither vectors (i.e. a kind of repetition code to provide redundancy), a spreading vector, the embedder, which has a quantization operation, and the decoder that performs a minimum distance decoding. The strength of STDM is adjusted by the length of spreading vectors and step size Δ. STDM has the exact same procedure with DM except applying a spreading vector.

For embedding, it is assumed that the information bits contain 0 and 1. Two dither vectors are generated from a random sequence and a step size A for bit 0 and bit 1, named dither_0 and dither_1. We have the spreading vectors. The following steps constitute the embedding process. 1) If bit 0 is selected, dither_0 is used for embedding (bit 1 case is the same). 2) Host media is projected on the spreading vector first. 3) The projected host media is added to dither_0 (or dither_1 in case of bit 1) and quantization is carried out. 4) Dither vector (dither_0 or dither_1) is then subtracted from the quantized result.

The following steps are carried out at the decoder. 1) The received media is first projected on a spreading vector. 2) Dither_0 and dither_1 are then added separately to the projected media. 3) Quantization is carried out and dither_0 and dither_1 are subtracted from the quantized results. 4) The two quantized results from dither_0 and dither_1 are subtracted from the projected media, and the two summations of all root-squared result from dither_0 and dither_1 are compared. 5) Then, the transmitted information bit is decided based on the smaller value of the summation (minimum distance decoding).

The main advantage of using QIM and STDM is the possibility of blind detection without having multimedia interference at the detector.

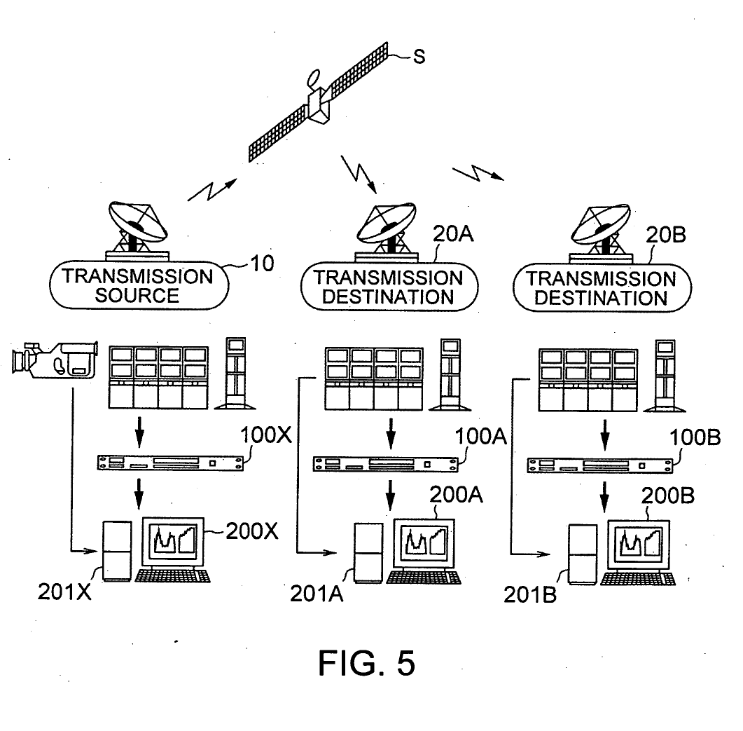

FIG. 5 is a schematic diagram of a transmission system that carries out an example of the novel monitoring method. In FIG. 5, a video/audio signal including an audio signal portion and a video signal portion is transmitted from a transmission source 10, such as a broadcasting station, to transmission destinations 20A and 20B, such as satellite stations. An example in which the transmission of such a video/audio signal is carried out through a communication satellite S is shown. However, the transmission may be through various means, for example via optical fibers.

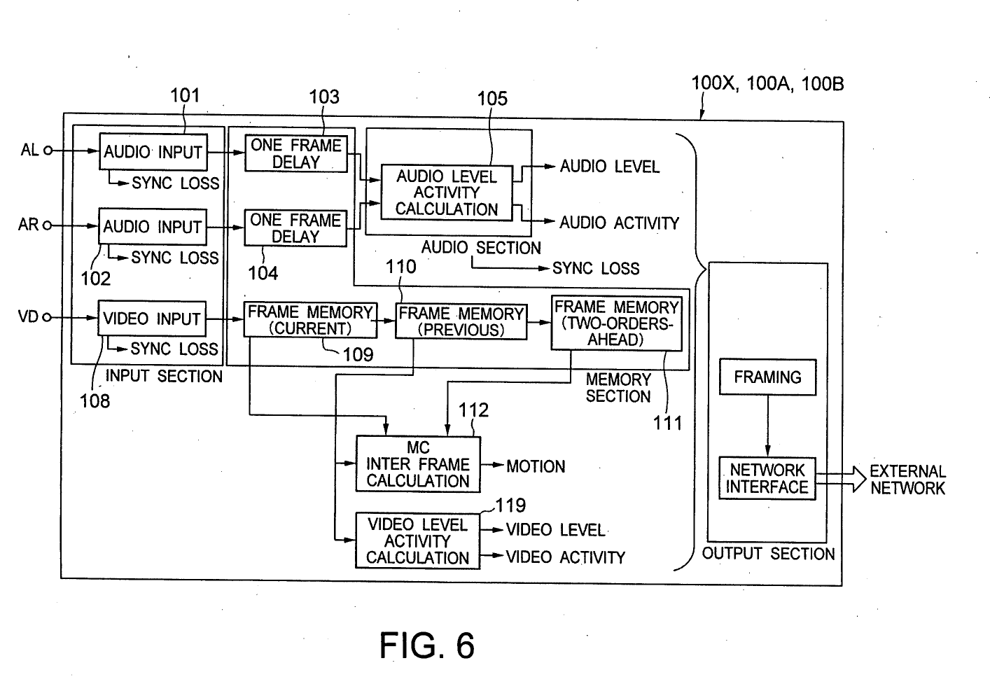

To calculate a video frame block variance, a video signal VD (see FIG. 6) is supplied into a video input section 108. The signal output from there is supplied to frame memories 109, 110, and 111. Frame memory 109 stores the current frame, frame memory 110 stores the previous frame, and frame memory 111 stores the frame before the two most recent frames. The output signals from frame memories 109, 110, and 111 are supplied to an MC inter-frame calculation section 112, and the calculation result thereof is output as the characteristic amount (Motion) of the video. At the same time, the output signal from the frame memory 110 is input into a video calculation section 119. The calculation result of the video calculation section 119 is output as the characteristic amount (Video Level, Video Activity) of the video. These output signals are output from extraction apparatuses 100X, 100A, and 100B to the terminals 200X, 200A, and 200B.

In one example, Motion is calculated as follows. An image frame is divided into 8 pixels×8 line-size small blocks, the average value and the variance of the 64 pixels are calculated for each small block, and the Motion is represented by the difference between the average value, and the variance of the blocks of the same place of the frame before N, and indicates the movement of the image. N is normally 1, 2, or 4. Also, the Video Level is the average value of the pixel values included in an image frame. Furthermore, for the Video Activity, when a variance is obtained for each small block included in an image, the average value of the variances of the pixels included in a frame may be used. Alternatively, the variance of the pixels in a frame included in an image frame may simply be used.

There are many advantages of using VDNA as the embedded video characteristic. A few of these advantages are listed below.

An audio signal has a higher probability of survival as compared to a video signal because the distortion in the audio is usually much less as compared to the distortion in the video when transmitted over common communication channels. Hence the characteristic embedded into the audio has a higher probability of correct detection. This makes the claimed monitoring method more robust.

In the claimed monitoring method, decoded parameters from the audio are compared to the parameters extracted from the received video frame. This means that there is a two-fold redundancy in the claimed monitoring method. First an algorithm checks for characteristic integrity in the audio, and second, the decoded parameters are compared to those extracted from the received video. This two-fold redundancy increases the probability of synchronization and correct detection of characteristics, as well as lowers the probability of a breach in security and copyright applications.

The usage of the claimed monitoring method does not impose any bandwidth increase on the transmitted video/audio with additional information.

There can be many possible applications of the claimed monitoring method technology. A few of these applications here. For example, this technology can be used to implement security and copyrights in digital videos (e.g. Digital Rights Management).

Since there are two versions of the same VDNA parameters available at the receiver, the novel monitoring method can also be used to assess video quality. The decoded VDNA from the audio can be compared to the extracted VDNA from the received video to determine possible quality loss. In addition to quality assessment, the movel method can also be used for correction and quality improvement. A few quality assessment and correction examples can be chroma difference, level change and resolution loss.

The novel method can also be used to correct and detect synchronization loss between audio and video in general and lip-sync in particular. Lip-sync is a very common problem in video transmission these days. Audio and video packets undergo different amounts of delays in the network and hence are out of synchronization at the receiver. Because of this, either the picture of a person talking is either displayed before the actual voice is heard or vice versa. This technology can be used to synchronize audio and video, and correct such errors. The receiver decodes the audio and compares the recovered first VDNA parameters to the extracted second VDNA parameters from a few video frames and synchronizes the audio with video such that the first and second VDNAs match.

In a VDNA-based lip-sync detection/correction system, the VDNA is first determined from the video sequence on a frame-by-frame basis. This first video characteristic is then embedded in the audio stream using STDM (or DM). The audio and video streams are then passed on to the encoder and the encoded bitstream is transmitted. At the receiver, the second VDNA is determined from the video stream after decoding. Also, the first VDNA is extracted from the audio stream. The first and second VDNA parameters are then compared. If the difference between them is greater than a specified threshold amount, then the system determines that a lip-sync error has occurred. Now, the VDNA parameter extracted from the audio stream is compared with the VDNA parameters extracted from some of the past video frames. If there is a match, the decoder synchronizes, using conventional methods, the audio stream with the matched video frame. If there is no match, the decoder waits for future frames and compares the VDNA (from audio) with video VDNA from future frames as they arrive at the decoder. As soon as it finds a match, it synchronizes the audio and the video.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A monitoring method for monitoring a video and audio signal transmitted from a transmission source to a transmission destination, the method comprising:
(a) determining a first video characteristic from the video and audio signal before the transmission;
(b) transmitting the first video characteristic to the transmission destination by embedding the first video characteristic in an audio portion of the video and audio signal;
(c) receiving the video and audio signal at the transmission destination and recovering the first video characteristic from the video and audio signal;
(d) determining a second video characteristic from the video and audio signal after the transmission; and
(e) using the first video characteristic and the second video characteristic to make a video quality determination.

2. The monitoring method of claim 1, wherein (e) involves determining whether an error occurred based at least in part on a difference between the first and second video characteristics.

3. The monitoring method of claim 2, further comprising:
(f) correcting the video and audio signal in response to the determination in (e) of whether the error occurred.

4. The monitoring method of claim 1, wherein the first video characteristic is a block variance of a difference between two video frames.

5. The monitoring method of claim 4, wherein the first video characteristic remains the same for all subsequent frames until the block variance of the difference between two video frames exceeds a predetermined amount.

6. The monitoring method of claim 1, wherein the first video characteristic is of a type not subject to damage by file compression.

7. The monitoring method of claim 1, wherein the first video characteristic is embedded into the audio portion using a Quantization Index Modulation method.

8. The monitoring method of claim 1, wherein the first video characteristic is embedded into the audio portion using a Spread Transform Dither Modulation method.

9. The monitoring method of claim 1, wherein the first video characteristic is of a type not subject to damage by format conversion.

10. The monitoring method of claim 1, wherein the same algorithm is used to determine the second video characteristic from the received video and audio signal in (d) as was used to determine the first video characteristic from the original video and audio signal in (a).

11. A method comprising:
(a) determining a first video characteristic from a video and audio signal;
(b) embedding the first video characteristic in an audio-portion of the video and audio signal; and
(c) transmitting the video and audio signal after the embedding of (b).

12. A method comprising:
(a) receiving a video and audio signal and extracting from an audio portion of the video and audio signal a first video characteristic;
(d) determining a second video characteristic from the video and audio signal after the receiving of (a); and
(e) using the first video characteristic and the second video characteristic to make a video quality determination.

13. A monitoring method for monitoring a video and audio signal transmitted from a transmission source to a transmission destination, the method comprising:
(a) creating a first characteristic value from a video portion of the video and audio signal before the transmission;
(b) transmitting the first characteristic value to the transmission destination by embedding the first characteristic value into an audio portion of the video and audio signal;
(c) creating a second characteristic value from the video portion of the video and audio signal after the transmission;
(d) examining at the transmission destination the first characteristic value to determine if it is in proper form;
(e) comparing the first characteristic value and the second characteristic value; and
(f) determining an error occurrence when, if the first characteristic value is in proper form, there is a difference of greater than a predetermined value between the first characteristic value and the second characteristic value.

14. The monitoring method of claim 13, wherein the video and audio signal transmitted to the transmission destination is corrected in response to the determining in (f) that an error occurred.

15. The monitoring method of claim 13, wherein the first characteristic value is a block variance value indicative of a difference between two video frames.

16. The monitoring method of claim 15, wherein the first characteristic value remains the same for all subsequent frames until the block variance of the difference between two video frames exceeds a predetermined amount.

17. An apparatus comprising:
means for determining a media characteristic value from a video and audio signal, and for embedding the media characteristic value into an audio portion of the video and audio signal; and
an output port through which the video and audio signal with the embedded media characteristic value is communicated.

18. The apparatus of claim 17, wherein the means embeds the media characteristic value using one of a Quantization Index Modulation (QIM) method and a Spread Transform Dither Modulation (STDM) method.

19. An apparatus comprising:
an input port through which a video and audio signal is received, the video and audio signal having an audio portion; and
means for recovering a first media characteristic value from the audio portion, for determining a second media characteristic value from a video portion of the video and audio signal, and for using the first and second media characteristic values to make a media quality determination.

20. The apparatus of claim 19, wherein the means is also for determining whether a lip-sync error has likely occurred.
